(19) United States
(12) Patent Application Publication
(10) Pub. No.: US 2010/0264640 A1
(43) Pub. Date: Oct. 21, 2010

(54) DEVICE FOR OBCURING PRINTED INDICIA AND METHOD OF USE

(76) Inventors: T. Randall Lane, Lebanon, OH (US); Steven L. Yeager, Miami Township, OH (US)

Correspondence Address: A PATENT LAWYER CORP, PLC;R WILLIAM GRAHAM, 22 S ST CLAIR ST, DAYTON, OH, 45402, US

(21) Appl. No.: 12/425,429

(22) Filed: Apr. 17, 2009

(51) Int. Cl. B42D 15/00; B41M 5/28

(52) U.S. Cl. 283/67; 503/200; 503/201; 283/81

(57) ABSTRACT

A device for obscuring printed indicia includes a printable substrate, an indicia printed on a first surface of the substrate, an irreversible thermochromic material operably associated with the printable substrate which does not affect readability of the indicia when not subjected to a predetermined critical temperature and when subjected to the predetermined critical temperature renders the indicia unreadable by virtue of a color change surrounding the indicia. The indicia can be a barcode. Methods of obscuring and use include the device.

### FIELD OF THE INVENTION

This invention relates to a device for obscuring printed indicia and method. More particularly, the invention relates to thermochromic changes affecting a barcode.

### PRIOR ART

Thermochromic materials typically reversibly change color with changes in temperature and have been made of semi-conductor compounds, from liquid crystals or using metal compounds. The change in color occurs at a determined temperature, which can be varied with additives. Current techniques are based on liquid crystals and leuco dyes. Liquid crystals are used in precision applications, as their responses can be engineered to accurate temperatures, but their color range is limited by their principle of operation. Leuco dyes allow wider range of colors to be used, but their response temperatures are more difficult to set with accuracy.

Thermochromatic Liquid Crystals (TLC's) are capable of displaying different colors at different temperatures. This change is dependent on selective reflection of certain wavelengths by the crystalline structure of the material, as it changes between the low-temperature crystalline phase, through anisotropic chiral or twisted nematic phase, to the high-temperature isotropic liquid phase. Only the chiral nematic mesophase (having no positional order) has thermochromic properties and consequently this restricts the effective temperature range of the material. Some such materials are cholesteryl nonanoate or cyanobiphenyls.

Liquid crystals used in dyes and inks often come microencapsulated, in the form of a suspension. Liquid crystals are used in applications where the color change has to be accurately defined, such as in thermometers.

Liquid crystals are difficult to work with and are typically more expensive than alternative technologies. High temperatures, ultraviolet radiation, some chemicals and/or solvents have a negative impact on their lifespan.

Thermochromic dyes are based on mixtures of leuco dyes with suitable other chemicals, displaying a color change (usually between the colorless leuco form and the colored form) dependent on temperature. The dyes are commonly in the form of microcapsules with the mixture sealed inside. An illustrative example is where microcapsules with crystal violet lactone, weak acid, and a dissociable salt dissolved in dodecanol; when the solvent is solid, the dye exists in its lactone leuco form, while when the solvent melts, the salt dissociates, the pH inside the microcapsule lowers, the dye becomes protonated, its lactone ring opens, and its absorption spectrum shifts drastically, therefore it becomes deeply violet. This is called halochromism. The dyes most commonly used are spiropyrans, spirolactones, fluorans, and fulgides. Weak acids include bisphenol A, parabens, 1,2,3-triazole derivates, and 4-hydroxycoumarin and act as proton donors, changing the dye molecule between its leuco form and its protonated colored form; stronger acids would make the change irreversible.

Leuco dyes have less accurate temperature response than liquid crystals, and have thus far been used in applications where accuracy is not required. They are suitable for general indicators of approximate temperature for various novelty items and as security features in checks and documents. They can be combined with some other pigment, producing a color change between the color of the base pigment and the color of the pigment combined with the color of the non-leuco form of the leuco dye. Thermochromics based on organic leuco dyes are available for temperature ranges between about 0° C. and 70° C., in wide range of colors. The color change usually occurs over an 8° C. interval.

Leuco dyes are commonly used in applications where temperature response accuracy is not critical such as novelties toys. Exposure to ultraviolet radiation, solvents and high temperatures reduce the lifespan of leuco dyes. This makes the use of incorporating leuco dyes in the manufacturing process difficult because of the temperatures above about 200-230° C. typically causes irreversible damage to leuco dyes.

One use is for thermal paper, where paper is impregnated with the solid mixture of a fluoran dye with octadecylphosphonic acid. This mixture is stable in solid phase but as octadecylphosphonic acid is melted, the dye undergoes chemical reaction in the liquid phase, and assumes the protonated colored form. This state is then conserved when the matrix solidifies again if the cooling process is fast enough.

Thermochromic material has been integrated into a variety of thermal sensitive labels, which are currently marketed. Some of these labels require colored solutions to be frozen and maintained frozen until placed on product. If the product is exposed to temperatures above the freezing point of the liquids in the indicator, the colored indictors will melt and mix creating a different color. Despite the use of such indicators, some activated indicator labels go unnoticed and the products are sold though having been subjected beyond critical temperature.

Thermochromics have been used as active components in temperature-specification devices, as shown in: U.S. Pat. No. 6,957,623 for a Critical Temperature Indicator; U.S. Pat. No. 6,544,925 for an Activatable Time-Temperature Indicator System disclosing an adhesive containing an activator for leuco dyes, wherein a film coated with the adhesive layer is bonded to commercial thermal paper, the activator in the adhesive migrates over time into the thermal paper causing a color change that is dependent on time and temperature; U.S. Pat. No. 6,472,22 for a Freeze Monitoring Device discloses a freeze indicator for measuring when a temperature goes below a certain value, not above a certain temperature; U.S. Pat. No. 5,695,284 for a Thaw Indicator Unit and Method of Manufacture discloses a thaw indicator aimed at low temperature food applications and requires colored solutions to be frozen and maintained frozen until placed on product and if product is exposed to temps above the freezing point of the liquids in the indicator, the colored indictors will melt and mix creating a different color; U.S. Pat. No. 4,28,748 for a Nonreversible Freeze-Thaw Indicator discloses a typical freeze indicator; U.S. Pat. No. 7,036,452 for Thermal History Indicators provide an indicator which must be kept frozen after production for use; and U.S. Pat. No. 6,685,094 discloses a barcode that changes the way it is read upon exposure to a specific temperature but does not obscure the barcode to render it unreadable.

Universal Product Code (UPC) barcodes are today's commonly used technique for matching a product against a pricing file and recording a sale. Unfortunately, these barcodes all fail to resolve the need for tracking environmental conditions such as critical temperature exposure. Currently, the UPC is used only for providing information in transacting data for the sale.

It is desired to improve the art of whereby products, which are temperature sensitive, can be both visually determined by a human operator and a computer aided device. Further, it is desirable to provide a relatively precise immediate color change at a predetermined temperature. It is also desirable not to require maintaining the indicator at or within a prior temperature range prior to its use on the product.

### OBJECTS AND ADVANTAGES

It is an object to provide a device for obscuring printed indicia.

A further object is to provide a method for obscuring printed indicia.

It is an object to improve critical temperature indicators.

It is another object to improve barcodes.

It is a general object to prevent temperature sensitive items, which have been exposed beyond a critical temperature, from being passed to a user.

Yet another object is to provide a barcode label which can shipped and stored at room temperature and activated when ready for use.

A further object is to provide a thermochromic barcode label which works with existing barcode readers.

Another object is to provide a barcode label which when subjected to a critical temperature becomes obscured by a color changing background rendering the barcode unreadable.

It is an object to provide a method of detecting whether an item has been subjected to critical temperature and preventing use of the same.

Accordingly, one aspect of the invention is directed to a device for obscuring printed indicia. The device includes a printable substrate, an indicia printed on a first surface of the substrate, an irreversible thermochromic material operably associated with the printable substrate which does not affect readability of the indicia when not subjected to a predetermined critical temperature and when subjected to the predetermined critical temperature renders the indicia unreadable by virtue of a color change surrounding the indicia. In one embodiment the indicia is a barcode.

A method for obscuring printed indicia. The steps include printing an indicia on a thermochromic substrate and subjecting said substrate to a critical temperature thereby obscuring the indicia.

Another aspect of the invention is directed to a barcode label which when subjected to a critical temperature becomes obscured by a color changing background rendering the barcode unreadable. The barcode label includes a printable substrate, a barcode indicia printed on a first surface of the substrate, an irreversible thermochromic material operably associated with the printable substrate which does not affect readability of the barcode indicia when not subjected to a predetermined critical temperature and when subjected to the predetermined critical temperature renders the barcode indicia unreadable by virtue of a color change surrounding the barcode indicia.

A method of detecting whether an item has been subjected to critical temperature and preventing use of the same is provided. The steps include applying a thermochromic barcode label to an article which is temperature sensitive preventing use of the article upon sensing a change in the thermochromic barcode label.

### DRAWING FIGURES

FIG. 1 shows an exploded perspective view of a thermochromic barcode of the instant invention.

FIG. 2 shows the barcode label of the instant invention in a readable state when not subjected to a critical temperature.

FIG. 3 shows the barcode label of the instant invention in an unreadable state when subjected to a critical temperature.

### DETAILED DESCRIPTION OF PREFERRED EMBODIMENT

Referring now to the drawings, the thermochromic barcode label of the instant invention is generally designated by the numeral 10. The barcode label 10 includes a printable substrate 4 having a printed barcode indicia 2 thereon. An irreversible thermochromic material 14 is operably associated with the printable substrate 4 (i.e., an irreversible temperature indicator is provided), which does not affect readability of the barcode indicia 2 when not subjected to a predetermined critical temperature, such as temperatures above its designated transition temperature, and when subjected to the predetermined critical temperature renders the barcode indicia 2 unreadable by virtue of a color change surrounding the barcode indicia 2. Thus, the instant invention provides a color change with a dual benefit of a human visual indication of the exposure to the critical temperature and an electronic indication of the exposure by rendering the barcode indicia 2 unreadable.

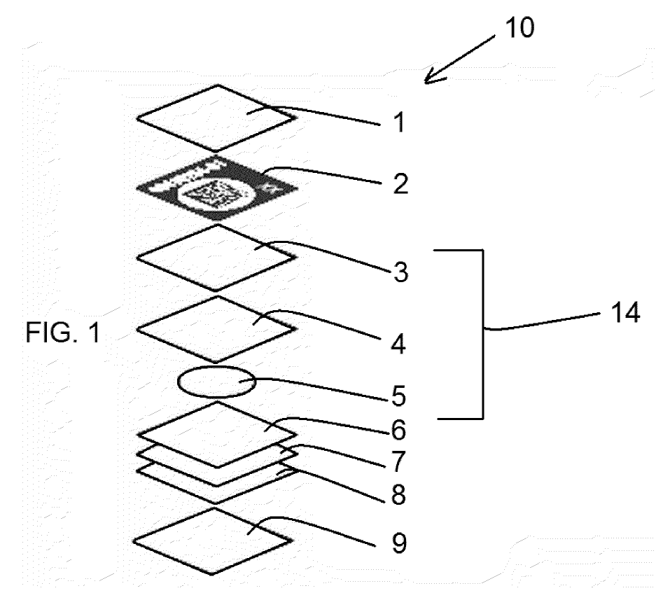

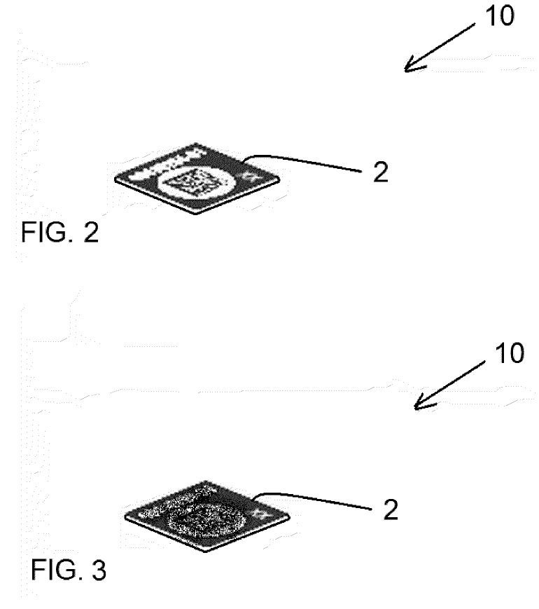

As can be seen in FIG. 1, an exploded diagram is provided of an exemplary configuration of the thermochromic barcode label 10. As seen, there are a plurality of layers 2-9 which will be described. Starting from a paper based substrate layer 4 and working upward, there can be provided an activation coating or layer 3 operatively applied to an upper surface thereon. Barcode indicia 2 is operatively applied to the activation coating 3 and a clear protective adhesive tape 1 can be operatively disposed atop of barcode indicia 2, activation layer 3, and paper based substrate 4.

Working downward from there, a color indicating compound 5 can be operatively applied to a lower surface of the substrate 4. An adhesive 6 can be operatively applied over the color indicating compound 5 and to the substrate 4. A film carrier 7 is applied to the adhesive 6. Another adhesive 8 can be operatively applied to film carrier 7. A release liner 9 can be applied to the adhesive 8 thereby forming the exemplary thermochromic barcode label 10.

Paper based substrate 4 can operably contain a combination of chemical(s), an example of which is described herein, that have a specific melt point temperature. The chemicals can be either freely dispersed within a coating or microencapsulated. The melt point determines the indication temperature of the label 10. A leuco dye can be blended with the melt point chemicals. When the chemicals melt, they dissolve the dye and carry it through substrate 4. The leuco dye is colorless until it bleeds through the substrate 4 and reacts with the activation coating 3 on the surface of the substrate 4, producing a color. The chemistry is directly behind the barcode indicia 2 such that the color develops in and around the barcode indicia 2.

The instant invention works with types of conventional single or multi dimensional barcode. The color and intensity of the leuco dye is such that a conventional laser barcode scanner (not shown) can no longer read the barcode indicia 2. The leuco dye can preferably be of a color that will absorb red light, since most conventional barcode lasers used in barcode scanners use red lasers. In the example provided, the arrangement of components in the diagram provide for protection of the chemistry in the label 10, such as layers 6-9 on the back and for adhering the label 10 to a product requiring monitoring. Clear protective adhesive tape 1 protects the barcode indicia 2 and adds to the appearance of the label 10.

In the instant example, the use of microcapsules in coating 5 allows for the production of label 10 that operates at room temperature and below but does not have to be stored below the melt point of the chemicals. The chemicals are held within the microcapsules and thus do not migrate through the substrate 4 until they are broken. This configuration requires for the label 10 to be conditioned to a temperature below the melt point of the chemicals so that they are solid. Then the label 10 is activated by applying pressure to break the microcapsule walls. So the instant invention provides a label 10 which can be stored without concern as to the critical temperature until ready to use at which point the label 10 can be handled in a manner to break the microcapsules thereby activating the label 10. When the label 10 is in use and placed on a product, which is subsequently subjected to a critical temperature, the chemicals melt and are free to migrate out of the ruptured capsules and through the substrate 4.

Unlike the many products available that can indicate exposure to a threshold temperature, there are no known products like the instant invention that also cause the barcode indicia 2 to become obscured so that it cannot be read by scanner. This dual function is unique. The chemistry by which the temperature indication occurs is unique as well.

The use of leuco dyes and an activator provides for darker color than standard solvent dyes. Because the leuco dye is initially colorless, lighter weight paper substrate 4 can be used and a thinner coating of color indicating compound 5 can be applied allowing the use of conventional printing methods.

Utilizing microencapsulation allows the product range to be increased to include temperatures just above room temperature to below 0° C. Unlike competitive products, which are shipped and stored below their indication temperature, the instant label 10 by virtue of the microencapsulation holds the active chemicals in a stable “container” until activated by pressure.

The temperature reactive chemistry is composed of two coatings, color indicating compound 5 (including a temperature sensitive coating carrying a leuco dye) is applied to the lower surface of the substrate 4 and an activator coating 3 applied to the upper surface of the substrate 4. The color indicating compound 5 applied includes either a specific melt point chemical or blend of chemicals that will melt at the desired temperature. They act to both control the temperature at which the label 10 responds and to carry the second component, a leuco dye, through the paper to the front of the label. The second component is a leuco dye that is colorless until activated with a lewis acid found in the activator coating. The chemistry is applied as a coating that is either a water-based emulsion or dispersion, but could be applied as 100% solids hot melt. A water-soluble binder bonds the components together and to the paper. The color indicating compound 5 can be applied by dotting methods and by conventional printing methods such as screen printing, flexography, and gravure.

Materials that can be used to determine melt point are pure and mixed straight chain alkanes (paraffins), branched alkanes, fatty alcohols, and fatty esters. Any chemical with the proper melt point that doesn't react with the dye or other label components, and is safe, is contemplated by the invention. For temperature indication below 85° C., straight chain alkanes and 1^{st} position fatty alcohols are preferred. Above 85° C., melt point chemicals can be chosen based on melt point, must be nonhazardous, and must be non-reactive with the leuco dye and other elements of label 10. These chemicals are in the water-based coating at 10 to 60%, preferably at 20-40%.

The preferred leuco dyes for use in this application are colorformers from the families of spirolactones, phthalides, fluorans, spiropyrans, and fulgides. Examples of such dyes are available under the trade name Pergascript by Ciba Geigy and are also available from Yamada Chemical. Pergascript Red I6B, Blue I2RC, and Yamada 500 have been tested in the invention. The melt point of the dye should be above the melt points of the melt point controlling chemicals to avoid premature coloration. There are leuco dyes known to melt as high as 206° C. Leuco dyes are in the water-based coating at a level of 0.1 to 10%, preferably 0.3 to 3%.

Solvent dyes are also effective and do not require an activator. In another formulation of the color indicating compound 5 there is a solvent dye which can be dotted onto the back of a standard paper substrate 4 and when the threshold temperature is reached, the color indicating compound 5 migrate to the front or upper surface of substrate 4 giving a visual indication. In this case, a thicker paper for substrate 4 is preferred to prevent the color indicating compound 5, which has a tint from the solvent dye, from being seen from the front, and therefore the dot of coating needs to be thicker to provide enough chemical to bleed through the paper substrate 4. Solvent dyes would be added to the coating formula at the same levels as the leuco dyes.

If microencapsulation is to be used, methods known to the art can used, such as complex coacervation, simple coacervation, interfacial polymerization, polycondensation, etc. can be employed. A preferred method is complex coacervation such as Carboxymethylcellulose and Gelatin. The internal phase of the microcapsules would contain the dye and the melt point controlling chemicals at similar ratios as in the non-microencapsulated coating.

Binders can be any water-based latex/emulsion or water-soluble polymer. A preferred binder is polyvinyl alcohol. Binder is present in the water-based coating at 0.1 to 10%, preferably 0.5 to 3%.

A rheology modifier is used to assist in either emulsification or dispersion of the components, and to control viscosity. A preferred rheology modifier is an acrylate/C10-C30 alkyl acrylate crosspolymer. This is added to the coating at a level of 0.01 to 5%, preferably 0.05 to 2%. Other additives, as known in the art, can be used to stabilize the coating such as viscosity modifiers, defoamers, dispersants, surfactants, and biocides.

The activator coating 3 is applied to the upper surface or top of the paper substrate 4 before printing with the barcode indicia 2. The activator coating's 3 functional component is a lewis acid capable of activating the leuco dye. Activators can be zincated resins, zinc salicylate, or acid clays. Other activators can be phenols, carboxylic acids, sulfones, etc. Binders and additives used for the activator coating are similar to those in the color indicating compound 5.

A preferred alternative to printing the activator coating 3 onto paper substrate 4 is to purchase a CF paper with an activation coating already applied. Such papers are available from Appleton Paper under the trade name NCR Paper™, and Glatfelter under the trade name Transmite™. An advantage to printing the activator coating 3 is if it is desired to form a color pattern or design to develop on the front or upper surface of paper substrate 4. Also specific sections of the barcode indicia 2 can be developed giving a different reading instead of a “no read.”

The temperature reactive chemistry, which includes color indicating compound 5, is applied to the lower surface or backside of the paper substrate 14 and separated from the activator coating 3 because this provides an accuracy of up to +/−1° C. If the activator coating 3 and leuco dye of the color indicating compound 5 were printed together the temperature range over which the color would develop would be much wider.

Lamination tape 1 is used to protect the chemistry from abrasion and contamination. It also improves the appearance of the label 10. Any adhesive is acceptable but in some cases a silicone adhesive may be preferred over an acrylic because the acrylic can interact with some of the melt point controlling chemicals and the opposite can be true as well.

### Example of Color Indicating Compound Formulation—58° C. (Layer 5 in FIG. 1)

| | Grams | % | Manufacturer |
|---|---|---|---|
| 1-Octadecanol | 11.64 | 19.4 | Sigma Aldrich |
| 1-Eicosanol | 7.76 | 12.93 | Alfa Aesar |
| Pergascript Blue I2RC | 0.6 | 1.00 | Ciba Geigy |
| Water | 39.308 | 65.51 | |
| Celvol 540 Polyvinyl alcohol | 0.64 | 1.07 | Wacker |
| Carbopol PEMTR1 | 0.052 | 0.09 | Lubrizol |
| | 60.0 | 100.00 | |

### Example of Activator Coating Formulation (Layer 3 in FIG. 1)

| | | | |
|---|---|---|---|
| Water | 24.4 | 54.10 | |
| Fulacolor WX | 20 | 44.34 | Rockwood |
| Celvol 540 Polyvinyl alcohol | 0.6 | 1.33 | Wacker |
| Tamol | 0.1 | 0.22 | Rohm & Haas |
| Dynol 604 | 0.005 | 0.01 | Air Products |
| | 45.105 | 100 | |

### Example of Microencapsulated Temperature Sensitive Coating (Layer 5 in FIG. 1)

| | Grams | % | Purpose |
|---|---|---|---|
| Gelatin | 6.0 | 2.78 | Forms microcapsule wall |
| Carboxymethylcellulose | 0.66 | 0.31 | Forms microcapsule wall |
| Water | 23.09 | 66.32 | Emulsification medium |
| 5% HCl solution | as needed | | |
| Tetradecane | 41.04 | 19.02 | Capsule core |
| Tridecane | 8.97 | 4.16 | Capsule core |
| Red 430 Solvent Dye | 0.25 | 0.12 | Capsule core |
| Polyvinyl alcohol | 1.8 | 0.83 | Binder |
| Water | 13.2 | 6.12 | Binder solvent |
| Xanthan Gum | 0.3 | 0.2 | Binder/Thickener |
| Amical Flowable | 0.46 | 0.20 | Biocide |
| | 215.77 | 100.00 | |

### Chemicals and Suppliers

| | | | |
|---|---|---|---|
| Alkanes | | Roper Thermals | Clinton, CT |
| | | Zeeland Chemicals | Zeeland, MI |
| Alcohols | | Cognis Corp. | Cincinnati, OH |
| | | Sigma Aldrich | Milwaukee, WI |
| | | Alfa Aesar | Ward Hill, MA |
| | | Sasol | Houston, TX |
| Fatty Acid Esters | | Cognis Corp | Cincinnati, OH |
| | | Alzo International | Sayreville, NJ |
| | | Lipo Chemicals | Paterson, NJ |
| Activators | Fulacolor | Rockwood Additives | Cheshire, UK |
| (lewis acids) | | SI Group | Schenectedy, NY |
| | | Sigma Aldrich | Milwaukee, WI |
| Leuco Dyes | Pergascript | Ciba Geigy Specialty Chem. | Tarrytown, NY |
| | | Yamada Chemical | Fukui, Japan |
| Polyvinyl Alcohol | Celvol | Wacker Chemical | Adrian, MI |
| Rheological Aid | Carbopol | Lubrizol | Wickliffe, OH |
| Wetting Agent | Dynol 604 | Air Products | Allentown, PA |
| Dispersing Agent | Tamol | Rohm & Haas | Philadelphia, PA |
| Gelatin | | Vyse Gelatin Co. | |
| Carboxy methyl cellulose | | Aqualon | Wilmington, DE |
| Glutaraldehyde | | Sigma Aldrich | Milwaukee, WI |
| Biocide | Amical Flowable | Dow Chemical | Midland, MI |

This invention has been described with respect the embodiments above. However, it should be realized that various modifications, changes and improvements may be made without departing from the scope of the invention and accordingly the claims appended hereto should be afforded such scope of protection.

What is claimed is:

1. A barcode label, which includes:
a printable substrate;
a barcode indicia printed on a first surface of said printable substrate;
an irreversible thermochromic material operably associated with said printable substrate which does not affect readability of said barcode indicia when not subjected to a predetermined critical temperature and when subjected to said predetermined critical temperature renders said barcode indicia unreadable by virtue of a color change surrounding said barcode indicia.

2. A barcode label of claim 1, wherein said irreversible thermochromic material is further characterized to be formed onto said substrate in a manner which requires activation prior to said barcode label use and wherein prior to said activation permits storage of said barcode label in temperature ranges which include said critical temperature.

3. A barcode label of claim 1, wherein said irreversible thermochromic material includes a color indicating compound operably disposed on a second surface of said substrate.

4. A barcode label of claim 3, wherein said irreversible thermochromic material includes an activator operably disposed on said first surface of said substrate.

5. A barcode label of claim 3, wherein said color indicating compound includes a carrier having a melting point at said predetermined critical temperature and a dye within said carrier.

6. A barcode label of claim 1, which includes a translucent protective substrate applied over said barcode indicia and in a manner to be disposed adjacent said first surface of said printable substrate.

7. A barcode label of claim 3, which includes a removably adhered substrate applied over said color indicating compound in a manner to be disposed adjacent said second surface of said substrate.

8. A method of detecting whether an item has been subjected to critical temperature and preventing use of the same, which includes the steps of:
(a) applying a thermochromic barcode label to an article which is temperature sensitive; and
(b) preventing use of said article upon detecting a change in the thermochromic barcode label.

9. The method of claim 8, which includes the step of activating the thermochromic bar code label prior to step (a).

10. The method of claim 9, wherein said activation include application of pressure to said thermochromic barcode label.

11. A device for obscuring printed indicia, which includes:
a printable substrate;
an indicia printed on a first surface of said printable substrate;
an irreversible thermochromic material operably associated with said printable substrate which does not affect readability of said indicia when not subjected to a predetermined critical temperature and when subjected to said predetermined critical temperature renders said indicia unreadable by virtue of a color change surrounding said indicia.

12. The device of claim 11, wherein said indicia is a barcode.

13. The device of claim 11, wherein said irreversible thermochromic material is further characterized to be formed onto said substrate in a manner which requires activation thereof wherein prior to said activation permits storage of said thermochromic material in temperature ranges which include said critical temperature.

14. The device of claim 11, wherein said irreversible thermochromic material includes a color indicating compound operably disposed on a second surface of said substrate.

15. The device of claim 11, wherein said irreversible thermochromic material includes an activator operably disposed on said first surface of said substrate.

16. The device of claim 14, wherein said color indicating compound includes a carrier having a melting point at said predetermined critical temperature and a dye within said carrier.

17. The device of claim 1 which includes a translucent protective substrate applied over said indicia and in a manner to be disposed adjacent said first surface of said printable substrate.

18. The device of claim 11, which includes a removably adhered substrate applied over said color indicating compound in a manner to be disposed adjacent said second surface of said substrate.

19. A method for obscuring printed indicia, which includes the steps of:
(a) printing an indicia on a thermochromic substrate; and
(b) subjecting said substrate to a critical temperature thereby obscuring said indicia.

20. The method of claim 19, which includes the step of activating the thermochromic substrate prior to step (a).

21. The method of claim 20, wherein said activation include application of pressure to said thermochromic substrate.

22. The method of claims 21, wherein said indicia is a barcode.
